(19) United States
(12) Patent Application Publication
(10) Pub. No.: US 2014/0321915 A1
(43) Pub. Date: Oct. 30, 2014

(54) Contamination treatment for soil

(71) Applicant: RETERRO, INC., Pleasanton, CA (US)

(72) Inventor: Patrick Richard Brady, Sisters, OR (US)

(73) Assignee: RETERRO, INC., Pleasanton, CA (US)

(21) Appl. No.: 14/264,005

(22) Filed: Apr. 28, 2014

Related U.S. Application Data
(60) Provisional application No. 61/817,298, filed on Apr. 29, 2013.

(51) Int. Cl. B09C 1/08

(52) U.S. Cl. CPC B09C 1/08
USPC 405/128.75

(57) ABSTRACT

Underground contamination can be treated with soil amended with oxygen gettering material. The treated soil can act as a reactive medium, creating a favorable environment to remove the contamination, such as breaking down the contamination into less harmful or harmless substances.

This application claims priority from U.S. Provisional Patent Application Ser. No. 61/817,298, filed on Apr. 29, 2013, entitled “Contamination treatment for soil”; which is incorporated herein by reference.

### BACKGROUND

Chlorinated hydrocarbons (solvents such as perchloroethene (PCE) and trichloroethene (TCE)) are classified as hazardous waste and are subject to Land Disposal Restrictions (Land Banned). Soils contaminated with land banned substances generally require treatment before the soils can be disposed into a hazardous waste landfill. The cost for land filling chlorinated hydrocarbon contaminated soil is high mainly due to the Land Disposal Restrictions and requirements.

Chlorinated hydrocarbons do not readily degrade in the subsurface. Groundwater becomes contaminated as it flows through contaminated soil. Chlorinated hydrocarbons have a specific gravity greater than 1 where the chlorinated hydrocarbon sinks in water. Contaminated soil creates a source for groundwater contamination and soil vapor contamination. Contaminated groundwater and soil vapor can carry chlorinated hydrocarbons great distances. Contaminated groundwater poses a threat to human health as groundwater can be used as a drinking water source. Contaminated soil vapor can enter into buildings exposing occupants to toxic vapors.

In contrast to non chlorinated hydrocarbons which degrade in the presence of oxygen and therefore can migrate a limited distance (for example, non chlorinated hydrocarbon plumes rarely exceed 400 feet from the source), chlorinated hydrocarbons do not degrade in the presence of oxygen, which causes them to migrate much further than non chlorinated hydrocarbons.

In situ treatment techniques are not efficient or effective especially in the source areas with high concentrations of PCE. For example, clay soil offers resistance to all in situ treatment methods.

Clay is a product of chemical weathering of rock and is typically found in low geologic energy environments, which are generally topographically flat areas. Most urban industrial/commercial areas are located in flat clay depositional areas. Other soil types including variations of silt, sand and gravel are products of physical erosion of rock. Clay is mainly composed of aluminum phyllosilicates. Clays are fundamentally built of tetrahedral silicate sheets and octahedral hydroxide sheets situated in a variety of arrangements. The phyllosilicates are held together with a weak electrical charge (Van Der Walls bond). Water is locked into the interlayers of the clay. Clay has a high capacity to absorb and store water and contaminants into its crystal lattice. Trapped water acts as an electrolytic solution within the clay, which causes clay to stick to it and other objects and also causes corrosion of buried metal objects.

### SUMMARY

In some embodiments, methods to treat contaminated ground soil are provided. The dehydrated treated soils are converted to a reactive media. The methods can include preparing an amount of treated soil, followed by placing the treated soil in the remedial excavation below the water table. The treated soil can create a favorable environment to remove the contamination, such as breaking down the contamination into less harmful or harmless substances. The treated soil can also contain reagents to react with the contaminants or promote the reaction of the contaminants, converting the contaminants into less harmful or harmless substances.

In some embodiments, the contaminants can include chlorinated hydrocarbons. The favorable environment can include a reducing ambient, such as an ambient with low oxygen concentration. The reducing ambient can promote anerobic biodegradation of chlorinated hydrocarbons, e.g., a reductive dechlorination, which can occur when the dissolved oxygen concentration is less than about 2 mg/l in groundwater.

In some embodiments, the treated soil can be prepared by drying the soil, and then adding materials to the soil when the soil is in a partial hydrated state. The dried state of the treated soil creates a unique opportunity to evenly mix amendments into the soil creating homogeneous mixture. The materials can include metal fragments, such as iron filings, and organic matter. Other materials can be used, such as soil nutrients. After adding the materials, the soil can be hydrated to an optimum soil moisture concentration where the soils can be compacted. The soil amendments become incorporated into the soil structure

In some embodiments, the treated soil can be in the ground, such as under the ground or under the water table. The treated soil can be activated, for example, by the oxidation of the iron filings, consuming the dissolved oxygen to create a reducing ambient. Reducing dechlorination process can occur to break down chlorinated hydrocarbon contaminants in the ground soil below the water table. The treated soil can be placed in contaminated areas to treat the contaminated ground soil and groundwater. The treated soil can be placed around de-contaminated ground soil to prevent re-contamination from the surrounding contaminated soil. The treated soil can be placed around contaminated ground soil to prevent contamination spreading from the contaminated soil.

In some embodiments, the treated soil can be the soil removed from contaminated ground. The soil can be treated to remove contaminants such as chlorinated hydrocarbons and non-chlorinated hydrocarbons. After the de-contamination, the soil can be further treated to form treated soil before returning to the ground. The treated soil can further treat the contaminants in the ground soil that has not been removed for ex-situ de-contamination.

### BRIEF DESCRIPTION OF THE DRAWINGS

FIGS. 1A-1B illustrate flow charts for treating contaminated soil according to some embodiments.

FIG. 2 illustrates a flow charts for treating contaminated soil according to some embodiments.

FIG. 3 illustrates a flow chart for treating contaminated soil according to some embodiments.

FIG. 4 illustrates a flow chart for treating contaminated soil according to some embodiments.

### DETAILED DESCRIPTION

In some embodiments, methods to treat contaminated ground soil are provided. For example, the methods can treat ground soil contaminated with chlorinated hydrocarbons.

Chlorinated hydrocarbons such as perchloroethene (PCE) can biodegrade in a reducing ambient, e.g., low oxygen ambient, below the water table. The process is known as reductive dechlorination, which generally occurs when the oxygen concentration dissolved in the ground soil is less than 2 mg/l.

In the reductive dechlorination process, a chloride atom in the PCE molecule (Cl₂C═CCl₂) can be replaced with a hydrogen atom, transforming PCE to trichloroethene (TCE, Cl₂C═CHCl). Replacement of a second chloride transforms TCE to cis- or trans-1,2-dichloroethylene (DCE, ClHC═CHCl), then DCE is transformed to vinyl chloride (ClHC═CH₂), and finally vinyl chloride is converted to the harmless substances ethylene (H₂C═CH₂) and chloride (Cl₂). Anaerobic degradation rarely precedes to completion in groundwater without intervention, leading to accumulation of vinyl chloride, a toxic human carcinogen. Vinyl chloride is the rate limiting step in reductive dechlorination. High concentrations of PCE and TCE found in source areas can inhibit vinyl chloride dechlorination

PCE is the most susceptible to reductive dechlorination because it is the most oxidized of the chlorinated hydrocarbon solvents. Vinyl chloride is the least susceptible to reductive dechlorination because it is the least oxidized of these compounds. The rate of reductive dechlorination decreases as the degree of chlorination. In situ methods that promote reductive dechlorination often tend to accumulate vinyl chloride, which is more toxic than PCE. Source areas, where PCE concentrations are high, pose a risk of creating significant concentrations of vinyl chloride as a result of reductive dechlorination.

In some embodiments, the methods of treating contaminated ground soil can include substantially reducing the PCE concentration in the source areas prior to in situ treatment of the ground soil to avoid generating high concentrations of vinyl chloride.

Since the groundwater typically has dissolved oxygen greater than 2 mg/l, reductive chlorination can be inhibited, which can make chlorinated hydrocarbons such as PCE a persistent contaminant in the subsurface.

In some embodiments, the methods of treating contaminated ground soil can include promoting reductive dechlorination in the ground soil. The reductive dechlorination promotion can include creating a reducing condition in the subsurface, together with optional organic matter, to sustain the dechlorination reaction to its completion. The process can thus reduce PCE and TCE concentrations to mitigate the vinyl chloride rate limiting step.

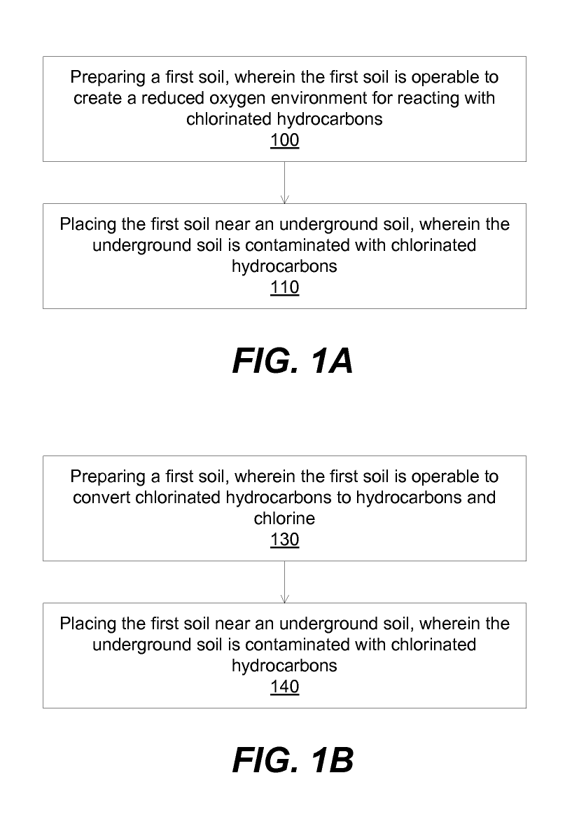

FIGS. 1A-1B illustrate flow charts for treating contaminated soil according to some embodiments. In FIG. 1A, operation 100 prepares a first soil. The first soil can be operable to create a reduced oxygen environment for reacting with chlorinated hydrocarbons. For example, the first soil can have an oxygen gettering material, e.g., a material that can easily react with oxygen or a material having high oxygen affinity. Operation 110 places the first soil at or near an underground soil, wherein the underground soil is contaminated with chlorinated hydrocarbons. The first soil can attract oxygen from the ambient, e.g., oxygen in the contaminated soil, to form an oxygen deficiency ambient. In the oxygen deficiency ambient, chlorinated hydrocarbons can be easily converted to less toxic substances, such as hydrocarbons and chlorine.

In FIG. 1B, operation 130 prepares a first soil. The first soil can be operable to convert chlorinated hydrocarbons to hydrocarbons and chlorine. For example, the first soil can contain an oxygen gettering material for generating a reduced oxygen ambient. The first soil can include materials that can promote the reaction from chlorinated hydrocarbons to hydrocarbons, e.g., a dechlorination catalyst such as palladium or iron. Operation 140 places the first soil near an underground soil, wherein the underground soil is contaminated with chlorinated hydrocarbons. The first soil can promote a dissociation reaction for the chlorinated hydrocarbons, converting the chlorinated hydrocarbons into less toxic substances such as hydrocarbons and chlorine.

In some embodiments, methods to treat chlorinated hydrocarbons contaminated ground soil are provided. The methods can include treating an amount of soil, such as clay, so that upon returning the soil to the ground, it can cause biodegradation of chlorinated hydrocarbons such as PCE and TCE. The treated soil can create a favorable environment to remove the contamination, react with the contaminants or promote the reaction of the contaminants, such as breaking down the contamination into less harmful or harmless substances.

In some embodiments, an oxygen gettering material, such as iron filings, can be incorporated into the soil so that when returning to the ground, the iron filings can be oxidized. The oxidation process can consume the dissolved oxygen in the ground, reducing the oxygen concentration of the ground to promote a biodegradation of chlorinated hydrocarbons. The amount of iron filings can be such that the resulted dissolved oxygen concentration is less than about 4 mg/l or about 2 mg/l.

In some embodiments, the oxygen gettering material can be added to the soil when the soil moisture concentration is below the optimum soil moisture concentration, such as at 30 to 70% of the optimum moisture concentration, which is between 5 to 20 vol %. Afterward, the soil is hydrated to the optimum moisture concentration, which can incorporate the added material into the soil lattice.

In some embodiments, the soil can contain clay, which can be subjected to a hydration treatment if the clay is dry, or which can be subjected to a de-hydration treatment if the clay is wet, e.g., to make the clay partially hydrated, e.g., to bring the moisture content of the clay to below the optimum moisture concentration. Amendments can be added to the clay. The amendments can include zero valent iron filings, nutrients and/or organic matter, and can be mixed with the partially hydrated clay. Further hydration to the optimum soil moisture concentration will incorporate the amendments into the clay crystal lattice.

In some embodiments, the amended hydrated clay is placed into the ground, for example, back to the dewatered remedial excavation below the water table and compacted in place, which further incorporates the amendments into the clay structure.

The electrical properties of the clay are reactivated as the result of hydration. The saturated conditions below the water table cause the iron filings to oxidize and corrode, which consumes the dissolved oxygen, for example, to below 2 mg/l. Reductive dechlorination occurs when the natural anaerobic bacteria begin to populate the remedial excavation amended backfill. The altered clay structure lends itself to exacerbate the reductive dechlorination process due to the disruption of the tetrahedral silicate and octahedral hydroxide sheets. The source area is void of soil contamination and is now dechlorinating the residual groundwater contamination that flows back into the remedial excavation. Groundwater quality greatly improves after the source area has been removed. The resulting reductive, nutrient rich groundwater flows along the same path as the original contaminants, which treat the residual groundwater plume.

Injections of reagents down gradient from the remedial excavation dilute the residual plume and treat the residual chlorinated hydrocarbons immediately adjacent to the injection sites. The lower concentrations associated with non source areas mitigates the issue of unabated vinyl chloride accumulation.

In some embodiments, the treated soil can be used to create reactive barriers around contaminated source areas not available for excavation (source areas under active buildings). Trenches can be advanced around a site to prevent the contaminant plume from moving further off site. The trench width can be designed to maintain enough residence time to produce reductive dechlorination within the trenches. As contaminated groundwater flows through the reactive barrier trenches, the chlorinated hydrocarbons will be dechlorinated to ethenes and produce a reductive nutrient rich plume moving along the same path as the original contaminant.

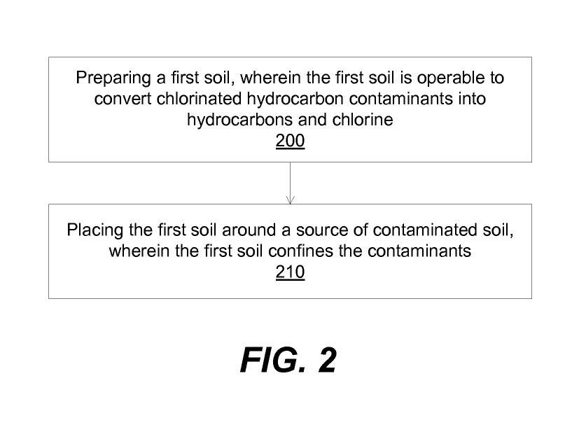

FIG. 2 illustrates a flow charts for treating contaminated soil according to some embodiments. Operation 200 prepares a first soil, wherein the first soil is operable to convert chlorinated hydrocarbon contaminants into hydrocarbons and chlorine. Operation 210 places the first soil around a source of contaminated soil to confine the contaminants. The first soil can be placed around a source of contamination to prevent the contamination from spreading. The first soil can be placed around a clean area, e.g., a contaminated area that has been decontaminated, to prevent the clean area from being re-contaminated from the surrounding area.

In some embodiments, the treated soil can be the soil removed from the ground, and treated to remove contaminant mass, for example, by evaporative desorption. The soil, after the contaminant mass has been removed, can be further treated to be used as a reactive media, for example, by amending the soil with amendment material such as oxygen gettering materal. The amended soil then can be placed into the subsurface below the water table to create a subsurface reductive dechlorination chamber. The non-combustive thermal desorption of volatile contaminates from low concentration contaminated earth is described in U.S. Pat. No. 6,829,844 (Brady et al) which is incorporated herein by reference in its entirety.

In some embodiments, the methods to treat contaminated ground soil can begin with excavating the source area to remove the source of groundwater and soil gas contamination. A decontamination process can include an evaporative desorption process to remove the chlorinated hydrocarbon (e.g., PCE) from the excavated soil. The evaporative desorption process can effectively and efficiently remove chlorinated hydrocarbons to non detectable levels and can be the only ex situ thermal process that can efficiently treat clay. For example, the evaporative desorption process can be capable of removing chlorinated hydrocarbons from soils including saturated clay soils. The evaporative desorption is a flameless thermal ex situ soil treatment process, which can control treatment temperatures by controlling the input treatment gas temperature and flow rate. Further, the evaporative desorption is a process that allows treatment parameters to be managed to optimize a specific treatment circumstance (air flow, temperature, residence time, type of treatment gas, oxygen concentration). The evaporative desorption can treat clay soils and create a natural amended media for reductive dechlorination within the backfill of an excavation.

After treatment, the dry clay is in a state which it can be used as a reactive media in the subsurface. Since the soil moisture has been removed from the clay, the clay structure can be manipulated to produce a reactive media.

The treated clay can be processed to bring chlorinated hydrocarbons to non detectable levels while preventing the formation of acetone and methyl ethyl ketone (MEK) and maintaining its dehydrated reactive nature. Acetone and MEK are formed when a clay soil, which contains relatively high concentration of natural total organic carbon (TOC), is heated. The TOC begins to thermally degrade initially forming acetone and MEK; simple alcohols. If left unchecked, the degradation of TOC will eventually form methane. The degradation process continues as long as the soil is maintained at elevated temperatures. The degradation process is controlled while the soil is inside the evaporative desorption treatment chamber.

In some embodiments, the treated soil, after removed from the evaporative desorption treatment chamber, can be further processed to stop the TOC thermal degradation process through rapid cooling through a hydration process to add moisture to the treated soil to a partially hydration level, e.g., below the optimum moisture content of the soil.

In some embodiments, the hydration process involves placing the treated clay soil in a flat thin soil pile and spraying water onto the pile in a controlled manner. Water can be mixed into the dry clay soil, for example, by an excavator equipped with a rock bucket (a bucket with teeth). One intent of the hydration process is to hydrate the clay just enough to stop the TOC degradation and to prevent the clay from absorbing any residual vapor phase chlorinated hydrocarbon. Minute amounts (low ppb level) of vapor phase chlorinated hydrocarbon can be absorbed into dry clay. Dry clay can act similar to activated carbon and absorb contaminants from the air. The hydration process not only cools the soil stopping acetone/MEK production it prevents the clay from absorbing contaminants. The clay is hydrated to a point below the optimum soil moisture concentration for compaction. Keeping the clay dry (below optimum moisture as determined by a geotechnical laboratory) maintains its ability to react with amendments.

Once the dry clay is partially hydrated, amendments can be added to the clay. For example, iron filings can be added to the partially hydrated clay. Other amendments can be included, such as nutrients and organic matters to fertilizing the soil and to promote a reductive dechlorination of the chlorinated hydrocarbon contaminants, for example, through the population of natural bacteria in the amended soil when placed to the excavated ground. The amended soil then can be further hydrated to the optimum soil moisture concentration. The two step hydration process can incorporate the amendments into the clay crystal lattice, improving the rate of dechlorination process of the contaminated ground soil.

In some embodiments, amendments can be added to the dry clay before the partial hydration process or after the final hydration process.

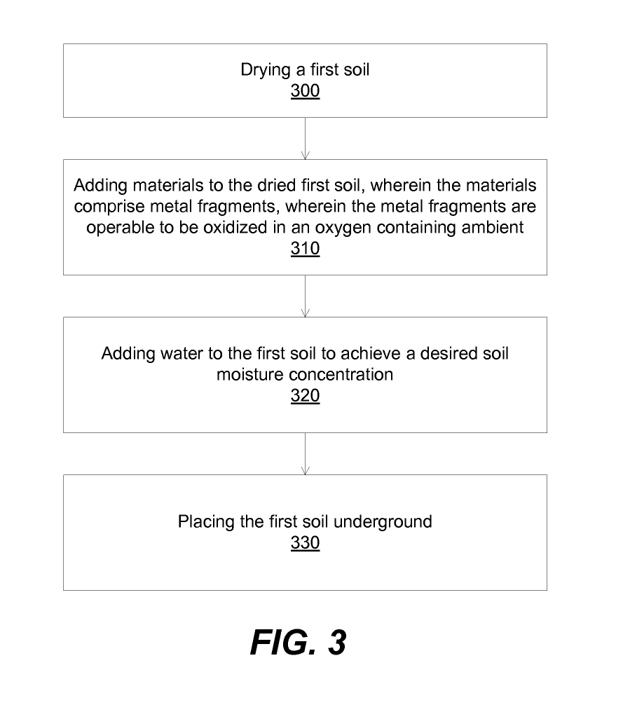

FIG. 3 illustrates a flow chart for treating contaminated soil according to some embodiments. Operation 300 dries a first soil. The drying process can include a decontamination process, for example, a thermal desorption process to remove hydrocarbon contaminations in the first soil. Operation 310 adds materials to the dried first soil. The materials can include oxygen gettering materials or high oxygen affinity materials, which can attract oxygen from nearby area. For example, the materials can include metal fragments, such as iron filings, which can be oxidized in an oxygen containing ambient to create a reduced oxygen ambient. The materials can be added to the first soil in the dried state, thus allowing high mixing to form a homogeneous mixture. For example, if the soil contains clay, dried clay can be easier to mix with materials than wet clay.

Additional materials can be added to the first soil. For example, organic materials can be added to promote the chlorinated hydrocarbon decomposition process. For example, fermentable organic materials can be added, such as mulch, which can produce hydrogen to promote the decomposition of chlorinated hydrocarbons. Further, adding organic matter in soil can increase the amount of microbial biomass and thus can induce organochlorine degradation. Nutrient materials can be added to the first soil, for example, to return the first soil to viable soil conditions.

Operation 320 adds water to the first soil to achieve a desired soil moisture concentration. The soil moisture concentration can have between 5 and 30 wt % water. Operation 330 places the first soil underground. Chlorinated hydrocarbons can be decomposed, due to the first soil.

In some embodiments, the first soil can be removed from the ground, and then treated to remove any contamination. The first soil can be treated further before return to the ground. For example, the first soil can be treated to create a reduced ambient to promote degradation of chlorinated hydrocarbons.

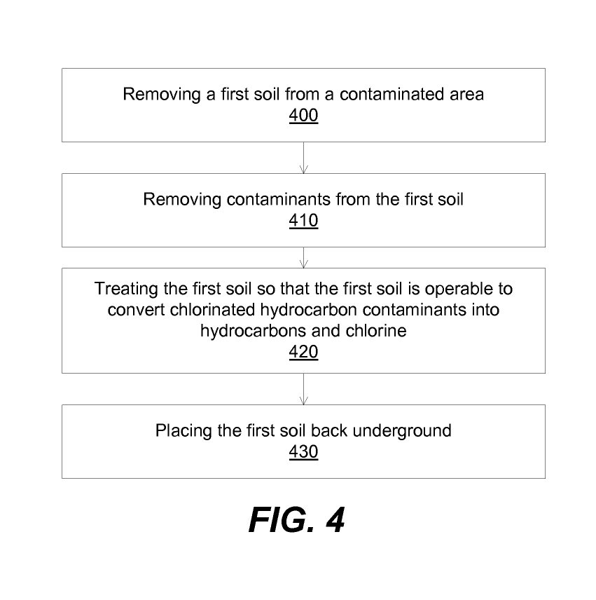

FIG. 4 illustrates a flow chart for treating contaminated soil according to some embodiments. Operation 400 removes a first soil from a contaminated area. Operation 410 removes contaminants from the first soil, for example, by a thermal desorption process. After the thermal desorption process, the first soil can be spread and can accept water spray. Operation 420 treats the first soil so that the first soil is operable to convert chlorinated hydrocarbon contaminants into hydrocarbons and chlorine. Operation 430 places the first soil back underground.

What is claimed is:

1. A method for treating contaminated soil, the method comprising
drying a first soil;
adding a first material to the first soil, wherein the first material comprises a high oxygen affinity material;
adding water to the first soil to achieve a desired moisture concentration;
placing the first soil underground.

2. A method as in claim 1
wherein the first material comprises iron filings.

3. A method as in claim 1
wherein the first material comprises organic matter and nutrients.

4. A method as in claim 1
wherein the dried first soil is configured to allow a homogeneous mixture with the first material.

5. A method as in claim 1
wherein the first soil is placed surrounding a contaminated underground soil.

6. A method as in claim 1
wherein the first soil is placed surrounding a de-contaminated underground soil.

7. A method for treating contaminated soil, the method comprising
excavating a first soil surrounding a contaminated soil, leaving an excavated area;
drying the first soil;
adding a first material to the first soil, wherein the first material comprises a high oxygen affinity material;
placing the first soil underground at the excavated area, wherein the first soil confines contaminants in the contaminated soil.

8. A method as in claim 7 further comprising
adding water to the first soil to achieve a desired moisture concentration.

9. A method as in claim 7
wherein drying the first soil further comprises decontaminating the first soil.

10. A method as in claim 7
wherein drying the first soil further comprises decontaminating the first soil by a thermal desorption process.

11. A method as in claim 7
wherein the first material comprises iron filings.

12. A method as in claim 7
wherein the first material comprises organic matter and nutrients.

13. A method as in claim 7
wherein the dried first soil is configured to allow a homogeneous mixture with the first material.

14. A method for treating contaminated soil, the method comprising
excavating a first soil at a contaminated area, leaving an excavated area;
drying the first soil;
adding a first material to the first soil, wherein the first material comprises a high oxygen affinity material;
placing the first soil underground at the excavated area, wherein the first soil is configured to treat contaminants entering the first soil from surrounding contaminated area.

15. A method as in claim 14 further comprising
adding water to the first soil to achieve a desired moisture concentration.

16. A method as in claim 14
wherein drying the first soil further comprises decontaminating the first soil.

17. A method as in claim 14
wherein drying the first soil further comprises decontaminating the first soil by a thermal desorption process.

18. A method as in claim 14
wherein the first material comprises iron filings.

19. A method as in claim 14
wherein the first material comprises organic matter and nutrients.

20. A method as in claim 14
wherein the dried first soil is configured to allow a homogeneous mixture with the first material.
